(19) United States
(12) Patent Application Publication
(10) Pub. No.: US 2007/0195798 A1
(43) Pub. Date: Aug. 23, 2007

(54) MEDIUM ACCESS CONTROL METHOD AND DEVICE

(76) Inventors: Jun Peng, McAllen, TX (US); Liang Cheng, Whitehall, PA (US)

Correspondence Address: PHILIP D FREEDMAN PC;PHILIP D FREEDMAN, 317 S. FAYETTE STREET, ALEXANDRIA, VA, 22314-5902, US

(21) Appl. No.: 11/676,979

(22) Filed: Feb. 20, 2007

Related U.S. Application Data
(60) Provisional application No. 60/775,293, filed on Feb. 21, 2006.

(51) Int. Cl. H04L 12/56; H04B 7/212

(52) U.S. Cl. 370/400; 370/443

(57) ABSTRACT

A wireless communications network comprises a plurality of nodes, comprising at least one receiver node; and at least one source node that communicates with the at least one receiver node via a communicating data channel; and a communicating control channel that transmits pulse control information to reserve the data channel for data communication.

### CROSS REFERENCE TO RELATED APPLICATION

This application claims the benefit of U.S. Provisional Patent Application No. 60/775,293, filed 21 Feb. 2006, which is hereby incorporated herein by reference.

### BACKGROUND OF THE INVENTION

The invention relates to a wireless communication network and particularly relates to transmitting broadcast information over shared packet data channels. More particularly, the invention relates to a wireless communications network that transmits pulse control information to reserve a data channel for data communication and to a data transmission method that transmits a single frequency wave pulse to reserve a data channel for data communication.

Communication media such as cables, fiber optics and radio spectrum can be shared by users in computer networks to improve medium utilization. Instead of being assigned to users as sub-channels as in telecommunications networks, computer networks are multiaccess systems, wherein media can be shared statistically by all its users.

Multiaccess communication is communication between or among several sources, or nodes, across a shared communication medium, for example communication via an Ethernet channel. When two or more multiaccess communication user stations or nodes transmit messages simultaneously via a shared communication medium, the messages can become corrupted. Consequently, a protocol for network medium utilization must be established to ensure that only one network station or node at a time can transmit into the shared-communications medium. This is important because network medium utilization directly impacts network throughput. Higher medium utilization allows more data packets to successfully traverse a network in a same time unit without collision. With a higher network throughput, nodes enjoy statistically higher flow throughput. Conversely, poor medium utilization sets a low and harsh limit on throughput.

A protocol is a set of rules that govern a network communications. One important protocol is the MAC protocol. Some MAC protocols depend on in-band control frames to reduce cost and chance of collisions. However, these protocols cannot detect a collision when it does occur. Another category of protocols employs one or more out of-band control channels. With these protocols, hidden terminals may be suppressed more effectively and thus the chance of collisions may also be reduced. However similarly, these protocols can not detect collisions when collisions occur.

There is a need for a wireless network protocol that reduces the chance of collisions and detects collisions when they occur.

### BRIEF DESCRIPTION OF THE INVENTION

The invention relates to a wireless network protocol that reduces packet collisions and detects the any collisions when they occur. The invention can be describe in an embodiment as a wireless communications network, comprising: a plurality of nodes, comprising at least one receiver node; and at least one source node that communicates with the at least one receiver node via a communicating data channel; and a communicating control channel that transmits pulse control information to reserve the data channel for data communication.

In an embodiment, the invention is a data transmission method for a communications system; comprising: transmitting a single frequency wave pulse to reserve a data channel for data communication; and transmitting data from a node of a plurality of nodes of the communication system via a common communications channel that is reserved according to a detected pulse with random-length pause or a fixed-length pause.

In an embodiment, the invention is A method to allocate a data channel of a multicarrier wireless network; comprising: sending at least one pulse wave with at least one random-length pause or with at least one fixed-length pause to sense and contend for a data communications channel access; and scheduling data packet transmission in the data communications channel according a response from a receiving station to the pulse wave.

### BRIEF DESCRIPTION OF THE DRAWING

FIG. 1 is a schematic representation of node disruption;

FIG. 2 and FIG. 8 are schematic representations of data frame capture;

FIG. 3, FIG. 4 and FIG. 5 are schematic representations of contention pulses;

FIGS. 6 and 7 are state transition diagrams;

FIGS. 9, 10, 11, 13, 14, 15, 19 and 20 are graphs of throughput versus network load;

FIG. 12 is a schematic diagram of hidden terminal regions; and

FIGS. 16, 17 and 18 are average medium access delay graphs.

### DETAILED DESCRIPTION OF THE INVENTION

Medium contention and hidden terminals are two major sources of packet collision in wireless packet networks. With the growth of various networks such as ad hoc networks and mesh networks, the collision problem has become increasingly important and dealing with collisions in wireless packet networks has become a critical problem.

“Contention-based” medium access network control advantageously provides a simple and robust improvement over schedule-based medium access control in wireless networks. Hence, this control is the most popular strategy in such environments. “Carrier sense” is a mechanism that is used to address the collision problem with contention-based strategies. With “carrier sense,” a node listens before it transmits. If the medium is busy, the node defers its transmission. After the medium has been idle for a specified amount of time, the node takes a random backoff before transmitting its frame. The random backoff avoids collisions with other nodes that are also contending for the medium.

But, the random backoff of a carrier sense mechanism may not avoid collisions, particularly when a network is heavily loaded with traffic or a large number of nodes are contending for medium. With heavy traffic and when a large number of nodes contend for medium, it is possible that two or more nodes may choose similar delays in their backoffs. In such a case, collision occurs.

The hidden terminal problem arises where two terminals or nodes can not sense each other due to distance or obstacles between them. IEEE 820.11 employs a technique called “virtual carrier sense” to alleviate this problem. IEEE 802.11 also known by the brand Wi-Fi, denotes a set of Wireless LAN/WLAN standards developed by working group 11 of the IEEE LAN/MAN Standards Committee (IEEE 802). The term 802.11x is also used to denote this set of standards. IEEE 802.11 employs a technique called “virtual” carrier sense to alleviate the hidden terminal problem in wireless networks. The virtual carrier sense technique is used to supplement the physical carrier sense technique.

The virtual carrier sense technique relies on in-band control frames to suppress hidden terminals. Before sending a data frame into an idle medium after proper deferral and backoff, a source sends out a Request To Send (RTS) frame to contact the receiver and reserve the medium around the source. Similarly, after receiving the RTS frame, the receiver sends out a Clear To Send (CTS) frame as a medium reservation to respond to the sender. Medium reservation information may also be carried in data frames. Data transmission begins upon an RTS and CTS successful exchange

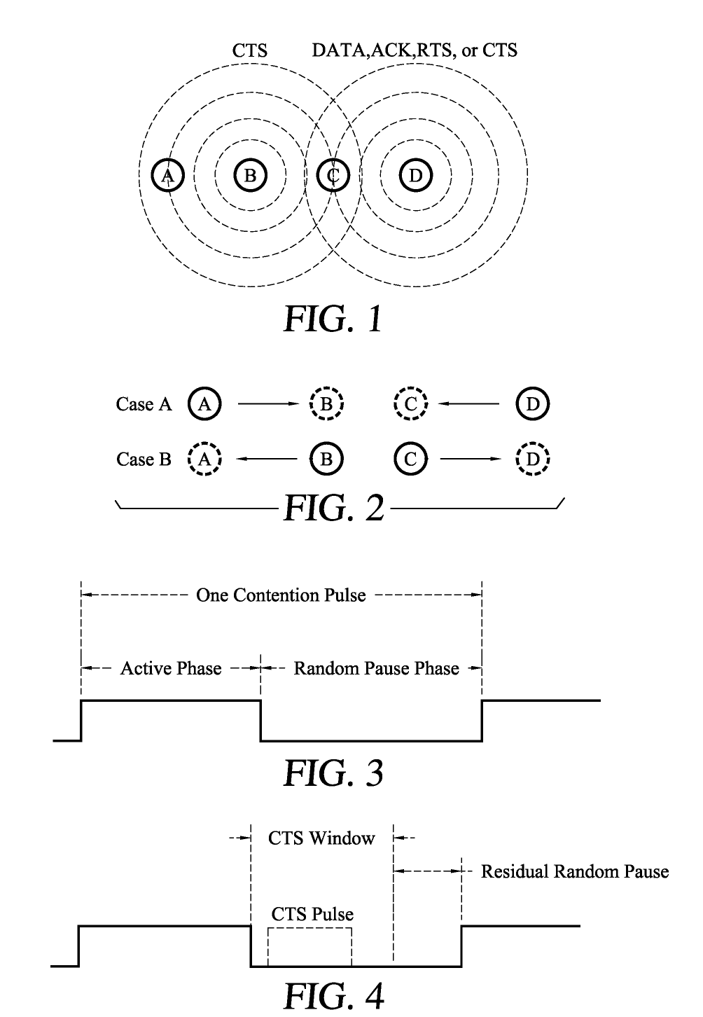

Several situations may cause difficulties with a virtual carrier sense technique. The first one is the “chained” hidden terminal phenomenon. A medium reservation message such as a CTS frame sent by a receiver to suppress a hidden terminal of the initiating sender may be lost within the receiver's neighbors due to the receiver's own hidden terminals. In such a case, some hidden terminals of the initiating sender may not be suppressed. An example is shown in FIG. 1. In FIG. 1, node A is an initiating sender and node B is a receiver. The CTS of node B is disrupted at node C (a terminal hidden by node A) by the signals of node D, which is a hidden terminal by node B.

Also, node mobility can limit virtual carrier sense technique effectiveness. With virtual carrier sense, only nodes that received medium reservation information know when to defer. So, a node newly moving into a neighborhood but having missed the reservation information becomes an unsuppressed hidden terminal to an on-going data transaction.

Another phenomenon that may impact virtual carrier sense is that the interference range of a node can be larger than its data transmission range. Therefore, even if a node is out of the range of another node for successfully receiving its CTS frame, the node may still interfere with the other node's data reception.

With a single channel, control information cannot be delivered when a data frame is in transmission. Hidden terminals therefore may not be suppressed. An out-of-band control channel can be effectively used as one way to improve control information delivery. With an additional channel, control signals can always be successfully transmitted.

Radio frequency spectrum can be spatially reused in a wireless network to improve network throughput. Spectrum reuse allows more transmissions to go on simultaneously without collisions. A phenomenon closely related to spectrum reuse is “capture.” In capture, one frame can be correctly decoded from a collision with another at a receiver if the power of the frame is higher than the power of the other frame by a threshold. Capture can enhance spectrum reuse in a wireless network.

Two capture cases are shown in FIG. 2. The FIG. 2 nodes are in a line to simplify demonstration. While capture takes place, the acknowledgment frames for the FIG. 2 cases may still result in interference. In the first shown case, nodes A and D are the initiating senders, while nodes B and C are their respective receivers. In the second case, nodes B and C are senders and nodes A and D are respective receivers. In these two cases, data frame capture can occur at the receivers because the data sources are much closer to their receivers than interference sources.

Reception acknowledgment for data frames is widely used in a MAC wireless network sublayer to combat high link error. With the MAC case, interference can arise not only from initiating senders but also from receivers. In the cases shown in FIG. 2, the two senders must finish data transmissions almost simultaneously for the data and acknowledgment frames to be received without error. For example, in case A shown in FIG. 2, if node A finishes data transmission before node D, then node B sends an acknowledgment frame to node A while node C is still receiving data. A collision then can occur at node C. Similarly, if node D completes transmission earlier, node B may have a collision. The problem exits for case B except that the corrupted frame is an acknowledgment rather than a data frame.

In one embodiment of the invention, a protocol uses a narrow bandwidth out-of-band control channel. The control channel carries information for medium access control, while the data channel is for data communications. The control channel employs a pulse to deliver the control information. The pulse can be a single-frequency wave with at least one random-length pause. Or, the pulse can be a single frequency random length wave with at least one fixed length pause. In an embodiment, the pulse is carried in the control channel. A sending node monitors the control channel to obtain channel state information. The monitoring is persistent except when data is being transmitted.

In this application, “pulse” is a signal having an active part and an inactive part. The active part is a portion of the pulse that is created by actively signaling for a fixed period. The inactive part is a portion created by the absence of a signal for a period. According to one protocol, the active and inactive parts of a pulse are signal transmitted at a particular level. The particular signal level of the active and inactive parts can comprise a selected signal from a plurality of signal levels to provide encoding of additional protocol information. The period of the active part of the pulse can be one of several pre-established fixed values that can convey information e.g. priority information, that can be established at a system level.

According to an embodiment of the invention, when a packet is to be sent, the monitoring node does a physical carrier sense and contention via the control channel. When the node is successful in contending for medium, it starts to transmit pulses in the control channel and shortly thereafter begins to transmit data frames in the data channel. The inventive random-length pulse protocol is not required to utilize RTS frames. However in an embodiment, a destination node can check the header of an arriving data frame and if the destination node determines that the frame is destined for it, the node can send back a CTS pulse (not a CTS frame) as soon as the current pulse of the sender pauses. The CTS pulse is sent back to the initiating sender during a pause of the initiating sender. The initiating transmitting node continues to transmit the data frame if it receives the CTS pulse. Otherwise, it stops transmitting in both channels. Even if the initiating transmitter receives a CTS pulse, it may release both channels if it detects a pause later in one of its pulses.

The pulses of the control channel can be repeated at a frequency that makes it feasible for a collision to be detected before the collision finishes by itself. Shorter pulses make collision detection earlier. However, not only do shorter pulses consume more bandwidth, but also they are more sensitive to delay variations in propagation and relay. In an embodiment, the random length pulse has a length that is comparable to that of a data frame. In an embodiment, 3 to 15 pulses can be transmitted during each data frame transmission. Desirably, 4 to 12 pulses are transmitted and preferably 5 to 10 pulses are transmitted during each data frame transmission.

The control channel pulses should be able to be sensed by all nodes in the interference distance of the pulse sender. A node is at its sender's transmission distance when it is within the longest distance at which a node can correctly receive a frame from the sender. If the transmission distance of each node is Dₜₓ, then the interference distance of a node is 1.78 Dₜₓ in a homogeneous network in free space. See K. Xu, M. Gerla and S. Bae, “How effective is the IEEE 802.11 RTS/CTS handshake in ad hoc networks?,” IEEE Globecom Conference, Taipei, Taiwan, November 2002, incorporated herein by reference in its entirety. Page 2 of Xu et al. describes Dₜₓ determination.

In an embodiment of the protocol, a receiver does not immediately declare the end of the active phase of a pulse when the power in the control channel falls below a threshold. The receiver only does so after the power remains below the threshold for a specified amount of time. The specified time can be set by pulse design, for example to a value between 20 to 30 microseconds, desirably between 22 to 28 microseconds and preferably from 24 to 26 microseconds in various implementations. With for example a 25 microsecond design, short fadings do not affect pulse detection.

FIG. 3 shows a contention pulse consisting of two phases, an active phase of a fixed length and a pulse phase of a random length. Busy-tone waves are transmitted in the control channel in the active phase only. The active phase of a contention pulse signals a busy data channel, while the pulse phase can be utilized for collision detection.

A node continues to monitor the control channel in its pulse pauses. Since only a transition delay of a couple of microseconds is required for an antenna to switch its state, the transition delay is small as compared to the duration of a pulse, which is usually several tens of microseconds. If a node detects a pulse during one of its pauses, the node stops transmitting in both channels. A CTS pulse is slightly different from a contention pulse. A CTS pulse will not have a pause phase and the length of its active phase can be determined by a field in the received MAC header of its data frame, which can contain an integer randomly selected by an initiating sender.

As already indicated, a CTS pulse can be sent back to an initiating sender in a pulse pause of the initiating sender. FIG. 4 illustrates delivery of a CTS pulse in a pause phase of a contention phase. A sender waiting for a CTS pulse, can segment its pulse pause into two parts. One is a CTS window, while the other is a residual pause of a random length. Size of the CTS window can be fixed and a CTS pulse can be designed to fit into this window. Then, only a CTS pulse of an expected length and received in a CTS window will be considered legitimate by an initiating sender.

Contention pulses also can be “relayed” by an intended data-frame receiver. The term “relay” is used in this context instead of “forward” to distinguish pulse spreading from packet forwarding. A receiver can start a relayed pulse upon the detection of an original pulse rather than waiting to receive the whole pulse. The active phase of a relayed pulse is however, shorter than that of an original pulse by a couple of microseconds so that the source of the original pulse will not detect the relayed pulse. Notice that when the source of the original pulse is still transmitting in the control channel, it can not detect any other pulses.

FIG. 5 demonstrates a transaction in the MAC sublayer with a random-length pulse protocol. In FIG. 5, node A is the sender. Node B is the receiver. And node C is a hidden terminal of node A. The figure shows the signals in the two channels of the three nodes. Because node C is a hidden terminal of node A. it can only receive signals transmitted (or relayed) by node B. In the figure example, the CTS pulse is delivered in the first pulse pause. In operation, a CTS pulse may not be necessarily transmitted in the first pulse depending on pulse parameters and the speed at which the data frame is transmitted.

According to IEEE 802.11 specification, a general MAC header for a data frame is 30-byte (240-bit) long. According to the invention, another field of, for example 1 byte (8 bits) can be added to the header to provide an expected length for a CTS pulse. Then, the total MAC header will have 248 bits according to an embodiment of the invention protocol.

As specified in IEEE 802.11. for a frequency-hopping spread spectrum (FHSS) physical layer, a physical layer convergence procedure (PLCP) preamble comprises 96 bits, while a PLCP header comprises 32 bits. Hence, the total physical layer PLCP header can be 128-bit long. In such a case, a MAC header can be received by 376 bits. If the data frame is transmitted at 2 Mb/s. then 376 bits can be transmitted in 188 μs. The physical layer may also do “whitening” on the payload, which can generate a delay of up to “8 octets” (IEEE 802.11 specification). In such a case, a total delay for a MAC header to be received by an intended receiver is below 220 μs (including propagation and processing delays).

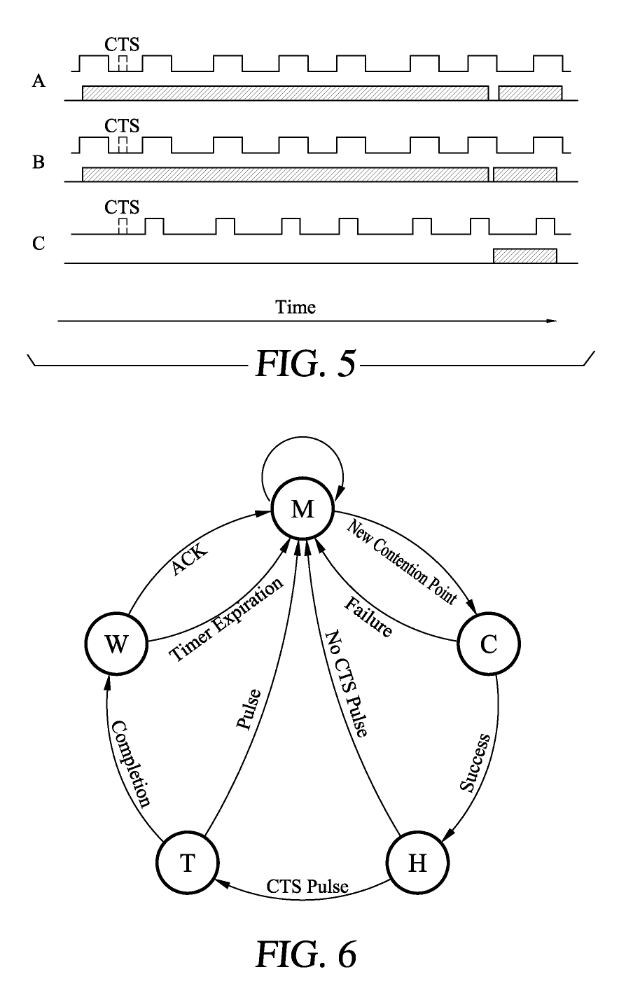

The following is a description of the random-length pulse protocol with respect to state transition diagrams. A first state transition diagram for a sender according to the random-length pulse protocol is shown in FIG. 6. Five states for a sender can be described according to the proposed protocol. These states are Monitoring, Contending, Handshaking, Transmitting, and Waiting-for-acknowledgment. In a Monitoring state, a node monitors the control channel to obtain channel states. When the MAC sublayer of the node receives a packet from an upper layer, the node becomes active but continues monitoring the control channel. When the control channel has been idle for a specified amount of time (i.e., when a contention point for medium service arrives), the active node enters the Contending state.

In the Contending state, the node starts a backoff timer for a random backoff: If the backoff timer expires successfully, the node enters the Handshaking state, in which the node generates pulses in the control channel and transmits its data frame in the data channel. If the node detects a pulse in the Contending state before its backoff timer expires, the node cancels its backoff timer and returns to the Monitoring state.

In the Handshaking state, the node looks for a CTS pulse in a pulse pause. If the node detects a CTS pulse, it continues to transmit its data frame and transits to the Transmitting state. Otherwise, the node returns to the Monitoring state. If the node in the Transmitting state detects a pulse in the control channel, it aborts transmissions and returns to the Monitoring state. Or, after a frame is fully transmitted, the node transits to the Waiting for-acknowledgment state. In a Waiting-for-acknowledgment state, the node looks for an acknowledgment from the receiver. After the reception of an acknowledgment or the expiration of a timer in the Waiting-for acknowledgment state, the node goes back to the Monitoring state. If the node receives no acknowledgment for its data frame, it will retransmit the data frame.

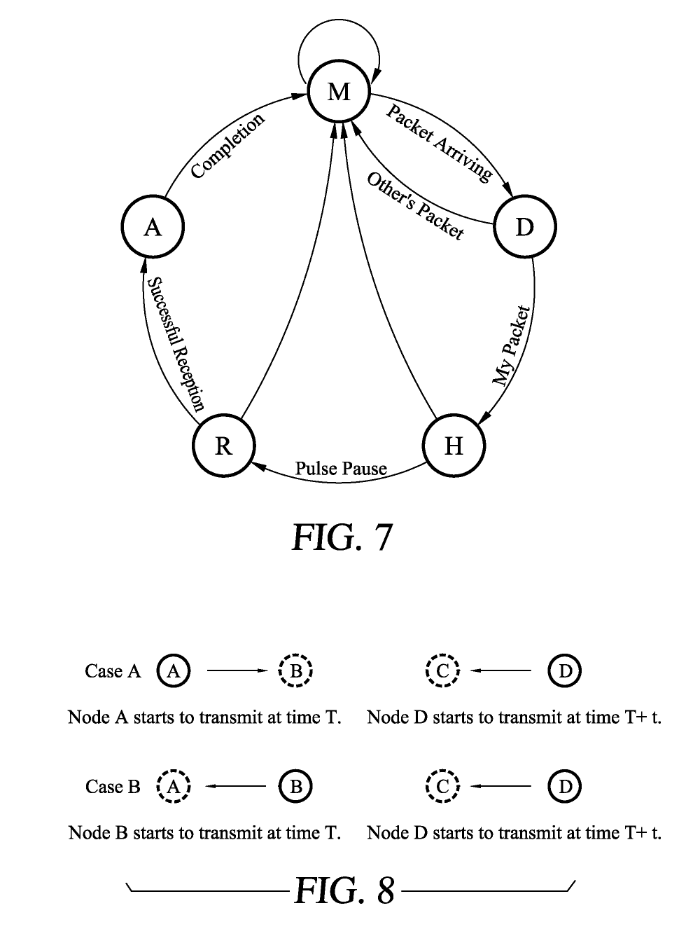

FIG. 7 is a state transition diagram for a receiver node showing five states—Monitoring, Determining, Handshaking, Receiving and Acknowledging. Initially, the node is monitoring and if it detects an incoming frame, it transits to the Determining state. In the Determining state, the node checks the MAC header of the incoming frame to determine if the frame is addressed to it. If the frame is addressed to it, the node enters a Handshaking state, in which the node continues to receive the frame and starts to relay the pulses in the control channel. If the frame is not addressed to the node, it returns to the Monitoring state.

In the Handshaking state, the receiver node will commence to transmit a CTS pulse as soon as the pulse in the control channel enters a pulse phase. After finishing sending the CTS pulse, the node transits to the Receiving state. However, if no pulse pause is detected, the sender terminates its transmission because of the lack of a CTS pulse and the receiver node returns to a Monitoring state. If the receiver node successfully receives the frame without error in the Receiving state, it enters an Acknowledging state, in which the node sends back an acknowledgment for the received data frame. After finishing transmitting the acknowledgment frame in the Acknowledging state, the receiver node ceases relaying pulses in the control channel and returns to the Monitoring state.

The following illustrates collision avoidance and detection according to a random-length pulse protocol.

Pulses (and busy tone waves) are more effective for suppressing hidden terminals than a CTS frame. (i) A CTS frame may not be correctly received by a node that can interfere with the CTS sender. Pulses, however, have low detectable power thresholds. (ii) A CTS frame can be easily corrupted by channel errors, while a pulse can not. (iii) A CTS frame only has a short appearance in the data channel before a data frame is transmitted. Pulses, however, are always in the control channel when a data frame is being transmitted. Therefore, medium contentions, instead of hidden terminals, are the main sources of collisions with a random-length pulse protocol.

When two nodes draw similar backoff delays at a contention point for medium service, they are not aware of each other and thus start to transmit signals in the two channels almost at the same time. If both receivers of the two senders can not correctly read the frame headers due to collision (i.e., the address or another field in the header does not have a legitimate value), neither node will send back a CTS pulse. In such a case, both senders will therefore terminate their transmissions and the collision is resolved automatically. If only one of the two receivers can correctly read the frame header, the sender of the other receiver will abort its transmission due to the lack of a legitimate CTS pulse. The collision is resolved in this case as well.

If both receivers of two transmitting nodes correctly read frame headers, only one sender will receive a legitimate CTS pulse; the other sender will back off automatically. In the case of at least two correctly read frame headers, one sender should abort transmission. The random-length pulse protocol will cause the pulses of the two or more senders to desynchronize with one other in their active phases as they pass on. After the desynchronization, one sender will detect the other and then release both channels. This collision detection mechanism is not restricted to two transmitting nodes neighboring to each other. Two nodes that are hidden terminals to each other may therefore still detect each other because of the relayed pulses.

FIG. 8 illustrates spectrum reuse method or system according to a random-length pulse protocol. FIG. 8 shows a transaction between nodes A and B that starts at time T. Node D commences to transmit to node C at T+t and while node A is still transmitting to B. In both cases A and B, data and ACK frames may not interfere with each other. Node C is a neighbor of node B and thus senses relayed pulses from B. But in this case, node C can correctly receive a frame from node D due to its short distance to node C. Node B's ACK frame does not interfere with node C's reception.

The difficulty for node C is to avoid interference on node B but respond to node D when necessary. There are two responses necessary. One is the CTS pulse, while the other is the ACK frame. First, node C needs to send back a CTS pulse when it can correctly read the header of the data frame from node D. However, relayed pulses from node B may make node C unable to detect a next pulse pause of node D. To address this problem, node C estimates the next pulse pause of node D from knowledge of the arriving time of the data frame from node D and the average length of a contention pulse. When the estimated time arrives, node C sends out a CTS pulse. The CTS pulse, however, may be relayed by node B and thus stop node A from transmitting. To deal with this interference, node A must back off in early stage data transmission. When its transmission has been well established (for example, after transmission of about a first one forth of the frame), node A will not abort its transmission even if it detects a pulse in one of its pulse pauses.

After node C finishes receiving the data frame from node D. it needs to send back an ACK frame. This ACK frame could interfere with node B's reception if node B is still receiving. However, node C knows that it is a neighbor of an on-going transaction when it detects pulses but does not receive a data frame in a short time. Also while node B is relaying pulses, node C does not receive pulses of regular parameter because node D is transmitting pulses too. Hence C avoids this interference by not sending back an ACK frame to node D having detected that node B is still in reception.

Sensitivity of an antenna of a sensing node determines pulse sensing distance and pulse transmission power. If a carrier-sense distance of a node is twice its transmission distance, pulses should use a power of ((1.78Dₜₓ)/(2Dₜₓ))⁴×Pₜₓ=0.63Pₜₓ in free space, in which Pₜₓ denotes transmission power in a data channel and “4” is the distance attenuation factor of radio power. In the FIG. 8 construction, the two channels have the same total gains for signals. However, two channels in two different frequency bands usually introduce different radio attenuation. To assure an intended coverage, pulses should use power higher than 0.63Pₜₓ.

### EXAMPLES

Features of the invention will become apparent from the drawings and following detailed discussion, which by way of example without limitation describe preferred embodiments of the invention. The following EXAMPLES illustrate the invention by testing simulations.

In this and the following EXAMPLES, the proposed protocol was compared with three other protocols. One was the CSMA/CA protocol specified by the IEEE 802.11; a second was the CSMA protocol (i.e., CSMA/CA without RTS/CTS). Both these protocols do not use an out-of-band control channel.

The third compared protocol was RI-BTMA, which uses a single control channel. Also, RI-BTMA employs a single busy tone for a receiver to deliver clear-channel information and reserve medium (i.e., suppress hidden terminals). In the RI-BTMA protocol implementations, data frames were acknowledged and retransmitted when lost, as in the other three protocols. In addition, an initiating sender in RI-BTMA generated single tone signals when receiving an acknowledgment frame to suppress hidden terminals of its receiver.

Hereinafter in this application, a protocol according to the current invention will be referred to as a “PulseAcc” protocol. In this EXAMPLE, the PulseAcc protocol took the following pulse parameters. The active phase of the pulse had a length of 50 μs, while the size of the CTS window was 150 μs. Additionally, the residual random pulse was drawn in a window of 50 μs. The length of a CTS pulse in the implemented PulseAcc protocol was randomly drawn in a set of 20, 40, 60, 80, and 100 μs.

Another important aspect of the EXAMPLE simulations was the utilization of [symbol] blank” broadcast frames of small intervals to simulate pulses and tones. “Blank” means that the frames carried no address or other information. When a node receives a blank frame at a power level above the carrier sense threshold of the control channel it detects a pulse or tone signal. The length of the pulse or tone signal is “measured” as a time segment during which such blank frames are continuously flowing.

The simulations evaluated the four protocols in an ad hoc network with a link bit rate of 2 megabits per second. The ad hoc network had 50 nodes in an area of 500 by 500 square meters. For RI-BTMA and PulseAcc, the control channel took the same power level as that of the data channel, which was 0.025 watts. The power level provided each node a data-transmission and carrier-sense range of about 150 and 300 meters, respectively. There were a maximum of 25 CBR flows in the network. The flows were randomly initialized. A dynamic source routing (DSR) protocol was used in the simulations.

### Example 1

Medium access control improves network throughput. If the throughput of a network is improved, a user experiences the improvement as a statistically higher flow throughput. The four protocols were first tested for flow throughput in a network with stationary nodes. Protocols performance was examined as traffic load in the network was varied. In particular, the protocols were tested in a series of simulations in which packet intervals of background traffic were varied from 1.0 to 0.0625 second with a decrease factor of 0.5 and packet size was 512 bytes. The test flow however, maintained a constant packet interval constant at 0.25 second to monitor actual throughput at various loads.

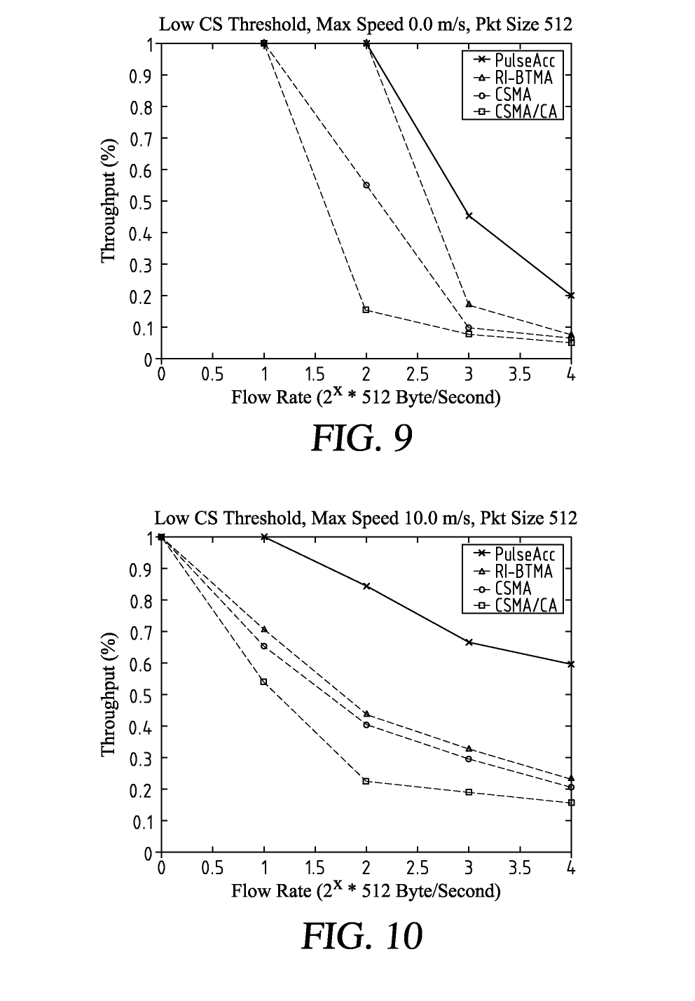

The simulation results are shown in FIG. 9. FIG. 9 shows percentage of throughput of test flow versus network load for stationary nodes, pkt. size 512 and default CS threshold. In FIG. 9, packet intervals were converted to flow rates, which determines network load. As shown in FIG. 9, the four protocols had similar performance when network load was light i.e., when packet interval of background traffic was 1.0 and 0.5 s. However, when the packet interval was decreased to 0.25 second, CSMA/CA showed a deep throughput decrease to about 20%. In the same case, CSMA throughput decreased to below 60%. Both RI-BTMA and PulseAcc however, maintained throughput at almost 100%. When the packet interval of background traffic further goes down to 0.125 s, the three comparison protocols had a throughput below 20%, while PulseAcc's throughput was close to 50%. When packet interval decreased to 0.0625 s. the throughput of the three comparison protocols was well below 10%, while PulseAcc maintained a throughput at about 20%.

Flow throughput shown in FIG. 9 displayed relatively flat changes after the network load increased to a specific level. In a network already saturated with traffic. The number of packets served by a medium in a time unit does not change substantially as traffic load increases; the excessive packets are mostly dropped by the link: queues of flow initiators. The actual bandwidth that a flow can obtain in the network therefore does not change dramatically in this case.

### Example 2

FIG. 10 shows throughput versus network load (maximum node speed 10 m/s, pkt size 512, default CS threshold). FIG. 10 illustrates throughput for a case in which nodes take random waypoint movement and have a minimum and maximum speed of 1 and 10 m/s, respectively (average pulse time was 0.58). Node movement can cause difficulties to both medium access control and routing thus decrease network throughput. However, node movement may increase throughput of a network too. For example, node movement may create new paths or connects broken paths in a network. In addition, node movement may also alleviate medium contentions at a hot spot in a network. All these phenomena can result in increased network throughput. Impact of node movement on a network can be determined by all these factors.

As shown in FIG. 10, after the introduction of node mobility, all protocols showed increased throughput on the higher end of network load but decreased throughput on the lower end. Gaps between PulseAcc and RI-BTMA, however, increased in almost every case.

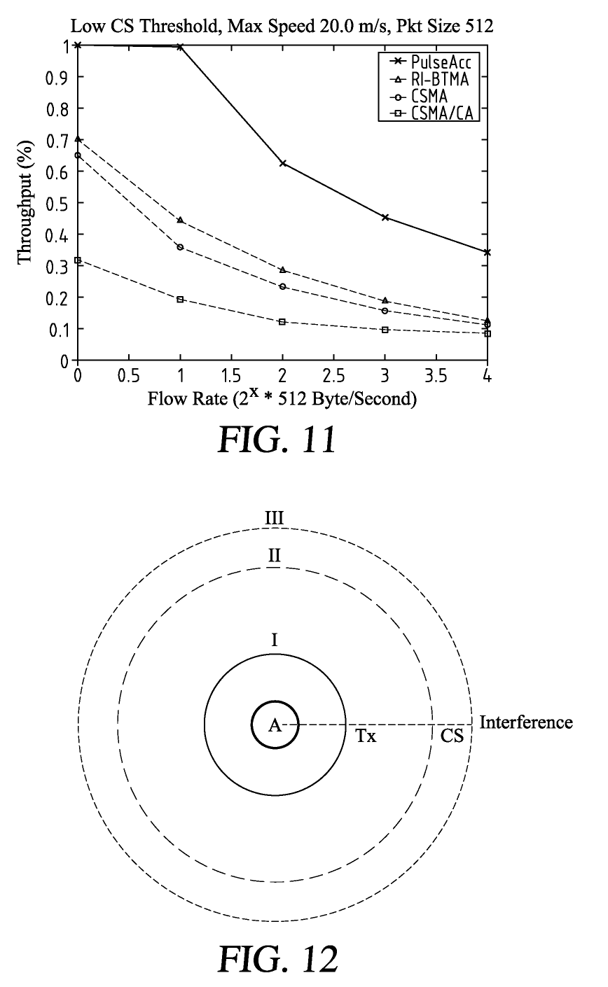

FIG. 11 shows throughput versus network load at maximum node speed 20 m/8, pkt size 512 and default CS Threshold. When maximum node speed was further increased to 20 m/8, more consistent throughput decreases were observed, as shown in FIG. 11. The throughput i decreased significantly as compared to the results in the case of a maximum node speed of 10 m/8. This decrease was particularly true for CSMA/CA, CSMA, and RIB1MA, where throughput dropped almost by half. PulseAcc, however, showed much less average drop.

### Example 3

In FIG. 12, ring I shows data transmission, ring II shows carrier sense, ring III: shows farthest interference. Ring II illustrates a region of hidden terminals with default NS-2 configurations. To investigate how hidden terminals may impact protocol performance, CS power threshold in the data channel was reduced to two times that of the packet reception threshold, effectively shrinking ring II.

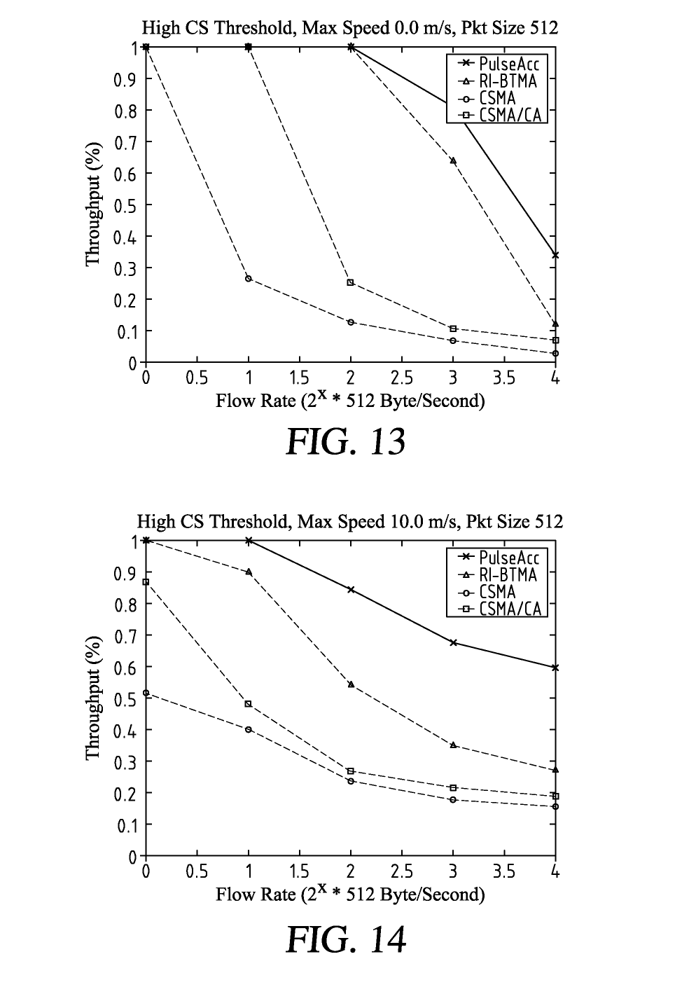

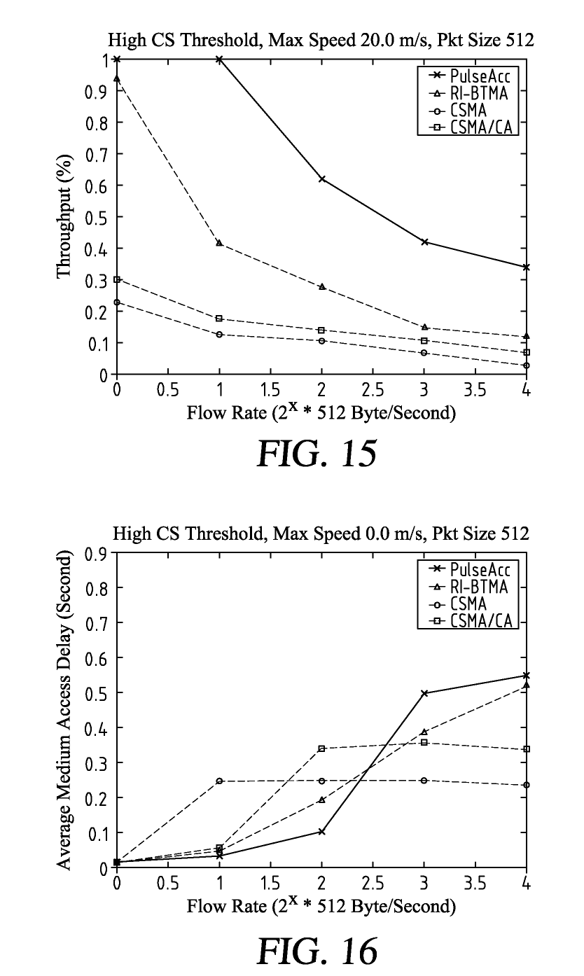

The simulation results for the case of increased CS threshold are shown in FIGS. 13, 14, and 15. These figures respectively show throughput versus network load (stationary nodes, pkt. size 512, high CS threshold) (FIG. 13), throughput versus network load (maximum node speed 10 m/s, pkt. size 512, high CS threshold) (FIG. 14) and throughput versus network load (maximum node speed 20 m/s, pkt size 512. high CS threshold) (FIG. 15).

These results illustrate that when there are higher chances of hidden terminals, PulseAcc shows higher performance gains over CSMA or CSMA/CA. In addition, CSMA/CA showed a clear advantage over CSMA. In this case of high chances of hidden terminals, CSMA/CA had a throughput difference from RI-BTMA that could not be explained by its RTS/CTS overhead, as shown in FIGS. 13, 14, and 15. Hence, the simulation results also show that CSMA/CA is limited in dealing with hidden terminals. C. Medium Access Delay

### Example 4

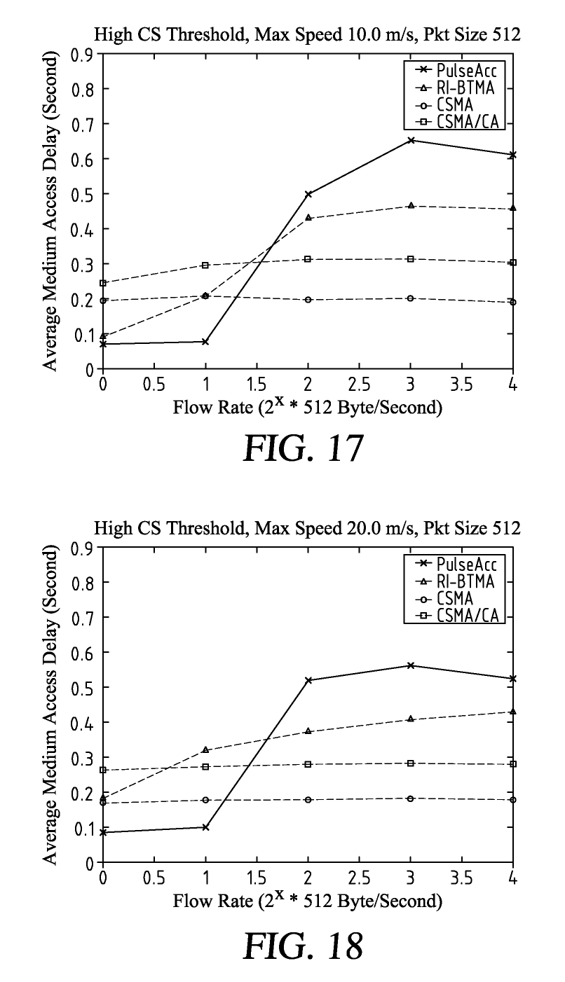

In this EXAMPLE, average medium access delays for the four protocols were averages on frames that successfully obtained reception acknowledgment. FIG. 16 shows average medium access delay for stationary nodes, high CS threshold. FIG. 17 shows average medium access delay for maximum node speed 10 m/s, high CS threshold). FIG. 18 shows average medium access delay for maximum node speed 20 m/s, high CS threshold. Frames that were discarded due to reaching relay limit were not counted in deriving the statistics because they were not served by the medium.

In general, higher throughput indicates lower medium access delay, since lower medium access delay allows more packets to go through the medium in the same time unit. The results shown in FIGS. 16, 17, and 18, however, do not always follow this rule. For example, see FIG. 16, subsequent to the packet interval reaching the 0.25 second interval. After 0.25 second interval, the rule is reversed, i.e., higher throughput is accompanied by higher medium access delay.

Two factors contributed to these results. One is that packets that are discarded due to reaching retry limits are not counted. A second is that background flows are initialized randomly. In the early stages of a simulation, network load is low and medium access delays are also low. As network load increases, i.e., more background flows are initialized, medium access delays increase. Some protocols then begin to discard more frames than others. As the process goes on, the low-throughput protocols gain advantages over higher-throughput protocols in medium access delay, since the higher-throughput protocols deliver more packets of high medium access delays. The same reasoning explains why average medium access delay for a protocol does not necessarily increase as network load increases in the FIGS. 16, 17, and 18 simulations.

### Example 5

This EXAMPLE illustrates shorter packet impact. Shorter packets may benefit protocols like CSMA because a packet collision has lower cost. On the other hand, shorter packets generate more network overhead. For example, to deliver 512-byte data in two packets instead of one doubles the cost of the headers in every layer.

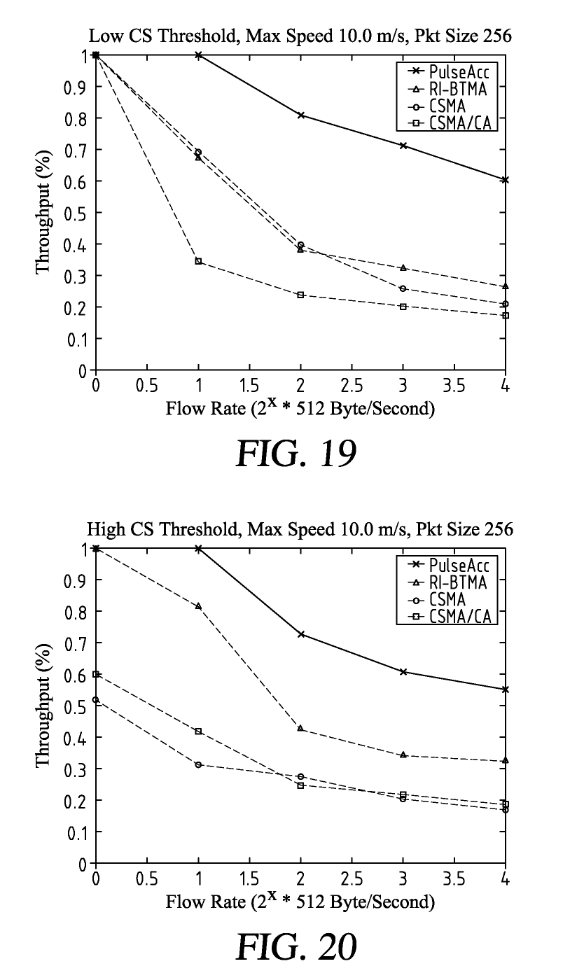

FIG. 19 shows throughput versus network load (maximum node speed 10 m/s, pkt size 256, low CS threshold). FIG. 19 illustrates a throughput for a case in which maximum node speed is 10 μs and the default CS threshold is used but packet size is decreased to 256 bytes.

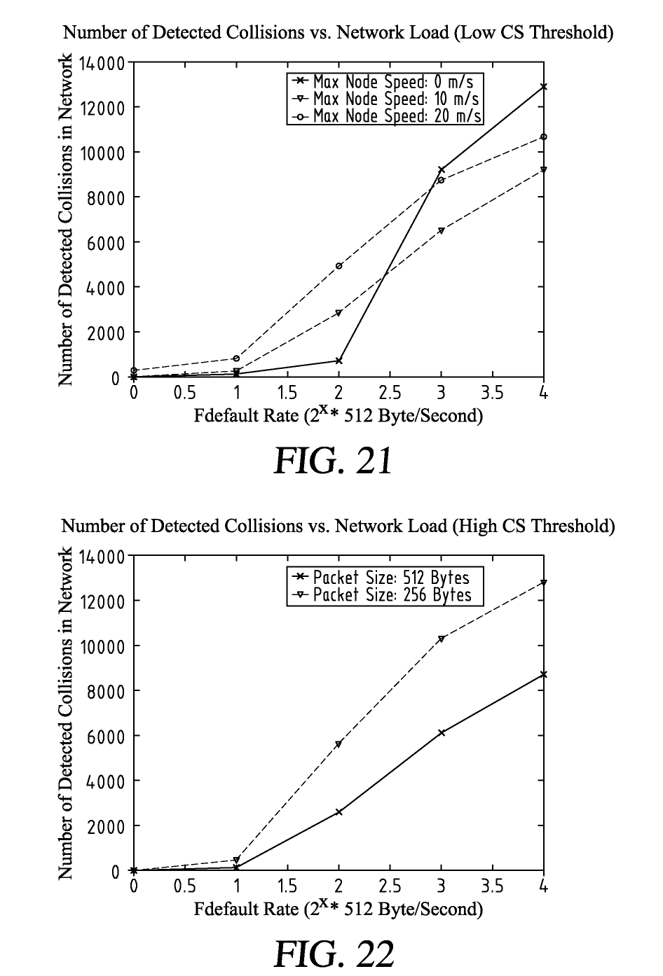

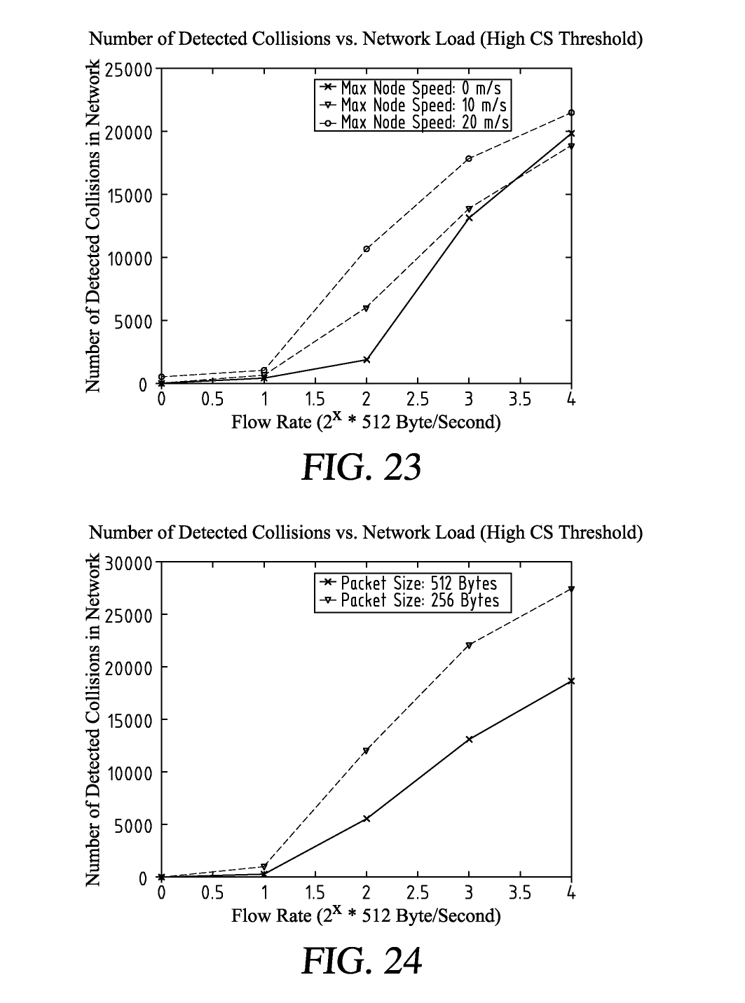

FIG. 20 illustrates throughput versus network. load (maximum node speed 10 m/s, pkt. size 256, high CS threshold). FIG. 20 shows results for the case of high CS threshold. These simulation results demonstrate that in the shorter packet case, all four protocols have lower or unchanged performance. Performance decrease is more apparent for CSMA/CA, RI-B1MA and PulseAcc than for CSMA. This illustrates that lower cost of collisions with short packets benefits the CSMA protocol more than others.

### Example 6

A strength of the proposed protocol is collision detection capability. In this EXAMPLE, FIG. 21 illustrates number of collisions detected in the network by PulseAcc in the case of default CS threshold. As shown in the figure, the number of detected collisions in the case of a maximum node speed of 10 m/s is consistently lower than that in the case of a maximum node speed of 20 μs. As shown in FIG. 10 and FIG. 11, flow throughput in the 10 m/s case is consistently higher than that in the 20 m/s case. A higher number of collisions in a network indicates severer medium contention, which decreases the medium utilization and hence network throughput.

Also, FIG. 21 illustrates that as network load goes from low to high, the number of detected collisions in the case of stationary nodes is first lower and then higher than that in the other two cases with node movement as shown in FIGS. 9, 10, and 11, flow throughput in the stationary-node case is first higher and then lower than that in the other two cases. Hence, the collision detection results conform to other results in these EXAMPLES.

Also FIG. 21 shows that in all the three cases, the number of detected collisions goes up slowly at the beginning of network load increase. Then collision detections increase faster as network load increases. The increase of the number of detected collisions finally slows down as network load further increases. This observation conforms to the above observation that as network becomes saturated with traffic, further increase of incoming traffic does not dramatically impact a MAC layer.

FIG. 22 shows number of collisions detected in the network by PulseAcc (the impact of packet size; default CS threshold). As shown in the figure, the number of detected collisions is significantly increased when packet size is halved. FIG. 22 illustrates how the number of detected collisions changes when packet size decreases.

FIG. 23 illustrates the number of collisions detected in the network by PulseAcc in the case of high CS threshold. As shown in the figure, the number of detected collisions is almost doubled as compared to that in the default CS threshold case shown in FIG. 21. Similar results are shown in FIGS. 22 and 24 for the case of a smaller packet size. The increase in collisions is caused by severe decrease of the CS threshold (more than 90% decrease). With severely decreased CS threshold, physical carrier sense loses its power and hidden terminals become common, which is the reason for the low performance of CSMA in the high CS threshold case.

The EXAMPLES illustrate that the inventive protocol detects collisions in wireless packet networks such as ad hoc networks or mesh networks. Using out-of-band contention pulses that have pulses of random lengths enables two transmitting nodes to detect each other. Pulses are “relayed” by destined data-frame receivers and therefore nodes that are hidden terminals to each other can also detect each other's simultaneous transmission. In addition, CTS pulses can be used with the protocol to assist collision detection and reduce control frames in a data channel. The simulation results of the examples show that the proposed protocol achieves improvement of network throughput in ad hoc networks as compared to existing protocols that can not detect collisions.

The inventive protocol can include a narrow-bandwidth, out-of-band control channel. The control channel bears information for medium access control, while a data channel provides data communications. Instead of relying on bit-based frames, the control channel employs pulses to deliver control information. The control channel pulses can be single-frequency waves with random-length pulses. In the proposed protocol, pulses only occur in the control channel and the control channel only carries pulses. For obtaining channel states, a node continuously monitors the control channel when transmitting in the channel. If a node is using the data channel but detects a pulse, it releases both channels.

With the proposed protocol, a node can do physical carrier sense in the control channel when it has a data packet to send. When the node is successful in contending for the medium, it can commence to transmit pulses in the control channel and shortly later, transmit the data frame in the data channel.

The proposed MAC protocol need not use RTS frames. However, a node checks the header of a data frame as soon as the header arrives. If the node determines that a frame is destined for it, it can send back a CTS pulse (not a CTS frame) as soon as the current pulse of the sender pauses. Meanwhile, the node can commence to “relay” pulses in the control channel. The initiating sender can continue to transmit the data frame if it receives the CTS pulse. Otherwise, it stops transmitting in both channels. Even if the initiating sender receives the CTS pulse, it may also release both channels if it detects a pulse later in one of its pulse pauses.

Using the pulse-based scheme reduces the amount of control information transmitted. This changes the ratio of control information to data payload information; this makes better use of the available bandwidth increasing the efficiency of the wireless media.

This efficiency pays valuable dividends in these two circumstances supported by wireless communication trends: 1) the raw data rate of the wireless media is increasing, the industry is trending toward faster and faster data rates, 802.11n specification has broken through 100 Mbs and WiMax and other W-WAN technologies have similarly high rates. In comparison most 802.11b WLAN are operating at 11 Mbs. 2) The number of nodes in a local wireless network is trending upward, standards like ZigBee are built to have 10's-100's of nodes in support of broad home automation applications, e.g. a node in every light-bulb socket is not unreasonable. As the number of nodes increases, a more efficient media access arbitration scheme will avoid congestion problems.

Further, the inventive protocol can provide an advantage with respect to multipath fading, which occurs when a signal reaches a receiver through multiple paths. Multipath fading is a common phenomenon in urban areas that is due to obstacles and reflectors. Multipath may cause fluctuating signal amplitude and phase, which are harmful for signal decoding. Pulses, however, are not as sensitive to multi path furling as bit-based frames. A pulse has a much longer duration than a bit in a frame. For example, if a data frame has 512 bytes of payload and there are 5 pulses in its transmission duration. Then each pulse has a length of at least 819 bits.

The pulse-based control protocol can achieve these design goals in a fully distributed way. The simulations show that the inventive protocol has outstanding performance gains in terms of network throughput in ad hoc networks as compared to existing protocols.

While preferred embodiments of the invention have been described, the present invention is capable of variation and modification and therefore should not be limited to the precise details of the Examples. The invention includes changes and alterations that fall within the purview of the following claims.

1. A wireless communications network, comprising:
a plurality of nodes, comprising at least one receiver node; and at least one source node that communicates with the at least one receiver node via a communicating data channel; and
a communicating control channel that transmits pulse control information to reserve the data channel for data communication.

2. The wireless communications network of claim 1, wherein the pulse control channel transmits control information via a single-frequency radio wave with a random-length pause.

3. The wireless communications network of claim 1, wherein the control channel transmits control information via a wave with a pulse of random-length pauses or a random-length wave with a pulse of fixed-length pauses to reserve the data channel for data communication.

4. The wireless communications network of claim 1, wherein the control channel comprises an out-of-band control channel.

5. The wireless communications network of claim 1, comprising at least one sending node that obtains channel state information.

6. The wireless communications network of claim 1, wherein the control channel is a medium access control channel that transmits a plurality of random length pulses.

7. The wireless communications network of claim 1, wherein the control channel transmits a plurality of single frequency waves with a random length pulse.

8. The wireless communications network of claim 1, comprising at least one receiver node that declares an end of an active phase of a pulse when the power in the control channel falls below a threshold for a predetermined length of time.

9. The wireless communications network of claim 1, comprising at least one receiver node that declares an end of an active phase of a pulse when the power in the control channel falls below a threshold for between 20 to 30 microseconds to avoid fading affect.

10. The wireless communications network of claim 1, comprising at least one receiver node that declares an end of an active phase of a pulse when the power in the control channel falls below a threshold for between 22 to 28 microseconds to avoid fading affect.

11. The wireless communications network of claim 1, comprising a receiver node that declares an end of an active phase of a pulse when the power in the control channel falls below a threshold for between 24 to 26 microseconds to avoid fading affect.

12. The wireless communications network of claim 1, comprising a plurality of nodes, wherein each node is within any other sender node's transmission distance.

13. The wireless communications network of claim 1, comprising a plurality of nodes, wherein each node is within 1.78 Dₜₓ of each other sender node, wherein each transmission distance of each node is Dₜₓ.

14. The wireless communications network of claim 1, comprising a sending node that does a physical carrier sense and contention via the control channel to contend for the data channel medium.

15. The wireless communications network of claim 1, comprising at least one destination node that checks a header of an arriving data.

16. The wireless communications network of claim 1, comprising at least one destination node that senses a header of an arriving data packet and transmits a CTS pulse back to the sending node during a pause in the sending node transmission.

17. A data transmission method for a communications system; comprising:
transmitting a single frequency wave pulse to reserve a data channel for data communication; and
transmitting data from a node of a plurality of nodes of the communication system via a common communications channel that is reserved according to a detected pulse of random-length pause or a fixed-length pause.

18. The data transmission method of claim 17, wherein the single frequency wave pulse comprise at least one random-length pause or at least one fixed-length pause to reserve the data channel.

19. The data transmission method of claim 17, comprising sensing the data channel medium and contending for data channel access via the wave with at least one random-length pause or at least one fixed-length pause.

20. The data transmission method of claim 17, wherein a receiving node senses a header of an arriving data packet and transmits a CTS pulse back to a sending node during a pause in the sending node transmission.

21. The data transmission method of claim 17, comprising transmitting single frequency wave with a pulse of at least one random-length pause or with a pulse of at least one fixed-length pause wherein the pulses are repeated at a frequency set to detect a collision.

22. The data transmission method of claim 17, comprising transmitting single frequency wave with a pulse of at least one random-length pause or with a pulse of at least one fixed-length pause wherein the pulses are repeated at a frequency of 3 to 15 pulses during each data frame transmission.

23. The data transmission method of claim 17, comprising transmitting single frequency wave with a pulse of at least one random-length pause or with a pulse of at least one fixed-length pause wherein the pulses are repeated at a frequency of 4 to 12 pulses during each data frame transmission.

24. The data transmission method of claim 17, comprising transmitting single frequency wave with a pulse of at least one random-length pause or with a pulse of at least one fixed-length pause wherein the pulses are repeated at a frequency of 5 to 10 pulses during each data frame transmission.

25. The data transmission method of claim 17, transmitting a wave with at least one random-length pause or the random-length wave with at least one fixed-length pause in a control channel to sense the data channel medium and contend for the data channel access and if successful, transmitting at least one data frame in the data channel.

26. A method to allocate a data channel of a multicarrier wireless network; comprising:
sending at least one pulse wave with at least one random-length pause or with at least one fixed-length pause to sense and contend for a data communications channel access; and
scheduling data packet transmission in the data communications channel according a response from a receiving station to the pulse wave.
